(19) United States
(12) Patent Application Publication
(10) Pub. No.: US 2018/0152391 A1
(43) Pub. Date: May 31, 2018

(54) COOPERATION METHOD AND RESOURCE ALLOCATION METHOD FOR COOPERATION BETWEEN IOT DEVICES INSTALLED IN ISG

(71) Applicant: Electronics and Telecommunications Research Institute, Daejeon (KR)

(72) Inventors: Mi Young HUH, Daejeon (KR); Ju Young PARK, Daejeon (KR)

(73) Assignee: Electronics and Telecommunications Research Institute, Daejeon (KR)

(21) Appl. No.: 15/822,541

(22) Filed: Nov. 27, 2017

(30) Foreign Application Priority Data
Nov. 25, 2016 (KR) 10-2016-0158061
Jul. 27, 2017 (KR) 10-2017-0095335

(51) Int. Cl. H04L 12/911; H04L 29/08

(52) U.S. Cl. CPC H04L 47/70; H04L 67/12

(57) ABSTRACT

Provided is a cooperation method and a resource allocation method for cooperation between internet of things (IoT) devices, a cooperation method between IoT devices installed in an IoT-based smart greenhouse (ISG) including processing data related to a target command and data related to a decision condition, selecting at least one particular device according to the processed data related to the target command, grouping the at least one device according to additional information received from the selected device and the processed data related to the decision condition, transmitting a first execution instruction to each of the grouped devices, regrouping the at least one device according to additional information newly received from the selected device and the processed data related to the decision condition or newly received data related to a decision condition after the grouping, and transmitting a second execution instruction to regrouped device.

### CROSS-REFERENCE TO RELATED APPLICATION

This application claims priority to and the benefit of Korean Patent Application No. 10-2016-0158061, filed on Nov. 25, 2016, and Korean Patent Application No. 10-2017-0095335, filed on Jul. 27, 2017, the disclosure of which is incorporated herein by reference in its entirety.

### BACKGROUND

### 1. Field of the Invention

The present invention relates to a cooperation method and a resource allocation method for cooperation between internet of things (IoT) devices. For example, the present invention relates to a cooperation method and a resource allocation method for cooperation between IoT devices, applicable to a system including IoT devices located in a predetermined space, and more particularly, applicable to an IoT-based smart greenhouse in which at least one IoT device is installed.

### 2. Discussion of Related Art

An internet of things (IoT) may refer to an environment in which everyday objects are connected via wired/wireless network to share information with each other. For example, representative examples of IoT-based devices may include various types of smart glasses, smart watches, smart bands, and the like that have recently been commercialized. However, the currently-discussed IoT environment has been studied only in a significantly limited area (the home, vehicle, and medical fields).

In particular, there has been a notable lack of research on essential modeling schemes that are required when combining IoT with agriculture field, such as farming, a greenhouse, a smart greenhouse, and the like, which has been spotlighted as a future industry.

### SUMMARY OF THE INVENTION

The present invention is directed to providing a modeling scheme (e.g., selection, grouping, and regrouping) for a cooperation method and a resource allocation for cooperation between internet of things (IoT) devices installed in an IoT-based smart greenhouse (ISG).

The present invention is directed to providing a technology for preventing unnecessary data loss and determining an optimal combination of IoT devices by defining a trigger condition for starting grouping and regrouping, which are required for modeling.

The technical objectives of the present invention are not limited to the above disclosure, and other objectives may become apparent to those of ordinary skill in the art based on the following descriptions.

According to one aspect of the present invention, there is provided a resource allocation method for cooperation between IoT devices installed in an ISG, including: receiving a first request message related to a target command; receiving a second request message related to a decision condition at a first point of time; selecting at least one particular device according to information included in the received first request message; receiving at least one of profile information, capability information, and operational status information from the selected at least one particular device at a second point of time; grouping the at least one device according to information included in the second request message received at the first point of time and the at least one of the profile information, the capability information, and the operational status information received at the second point of time; receiving a second request message related to a decision condition at a third point of time; receiving at least one of profile information, capability information, and operational status information from the selected at least one particular device at a fourth point of time; and regrouping the at least one device according to the decision condition received at the first point of time or the third point of time and the at least one of the profile information, the capability information, and the operational status information received at the second point of time or the fourth point of time.

According to one aspect of the present invention, there is provided a cooperation method between IoT devices installed in an ISG including: processing data related to a target command and data related to a decision condition; selecting at least one particular device according to the processed data related to the target command; grouping the at least one device according to additional information received from the selected at least one particular device and the processed data related to the decision condition; transmitting a first execution instruction to each of the grouped at least one device; regrouping the at least one device according to additional information newly received from the selected at least one particular device and the processed data related to the decision condition or newly received data related to a decision condition after the grouping; and transmitting a second execution instruction to each of the regrouped at least one device.

Further scope of applicability of the present invention will become apparent based on the following description. However, since many alternatives, modifications, and variations falling within the spirit and scope of the principles of this disclosure should be apparent to those skilled in the art, it should be understood that the description and the embodiments are intended to be illustrative.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram including elements of an internet of things (IoT)-based smart greenhouse (ISG) according to an embodiment of the present invention;

FIG. 2 is a diagram illustrating a detailed procedure of “selection” in a modeling process according to an embodiment of the present invention;

FIGS. 3 and 4 are detailed diagrams illustrating a “grouping” procedure in a modeling process according to an embodiment of the present invention;

FIG. 5 is a detailed diagram illustrating a “regrouping” procedure in a modeling process according to an embodiment of the present invention;

FIG. 6 is a diagram in which a “virtual device” is additionally considered in a modeling process according to an embodiment of the present invention;

FIG. 7 is a diagram in which an “exceptional condition” is additionally considered in a modeling process according to an embodiment of the present invention;

FIG. 8A and FIG. 8B are flowcharts showing an overall modeling process according to an embodiment of the present invention; and

FIG. 9 is a view illustrating an example of a computer system in which a method according to an embodiment of the present invention is performed.

### DETAILED DESCRIPTION OF EXEMPLARY EMBODIMENTS

Hereinafter, embodiments of the present invention will be described in detail with reference to the accompanying drawings. In the drawings, parts identical to those throughout the drawings will be assigned the same number, and redundant descriptions thereof will be omitted. The suffixes for elements used in the following description “module,” “part,” and “unit” have only been assigned or used together in consideration of the ease of drafting and do not distinguish meanings or roles therebetween. In the description of the embodiments, detailed descriptions of related known techniques will be omitted to avoid obscuring the subject matter of the present disclosure. In addition, the accompanying drawings are used to aid in the understanding of the embodiments of the present invention, and are not intended to limit the technical spirit of the present invention, and cover all modifications, equivalents, and alternatives falling within the spirit and scope of the present invention.

It should be understood that, although terms including ordinal numbers, such as first, second, etc., may be used herein to describe various elements, these elements are not limited by these terms. These terms are only used to distinguish one element from another element. It should be understood that, when an element is referred to as being “connected to” or “coupled to” another element, the element can be directly connected or coupled to the other element, or intervening elements may be present. Conversely, when an element is referred to as being “directly connected to” or “directly coupled to” another element, there are no intervening elements present.

As used herein, the singular forms “a,” “an,” and “the” are intended to include the plural forms as well, unless the context clearly indicates otherwise.

It should be further understood that the terms “comprises” and/or “comprising,” when used in this specification, specify the presence of stated features, integers, steps, operations, elements, components, and/or groups thereof, but do not preclude the presence or addition of one or more other features, integers, steps, operations, elements, components, and/or groups thereof.

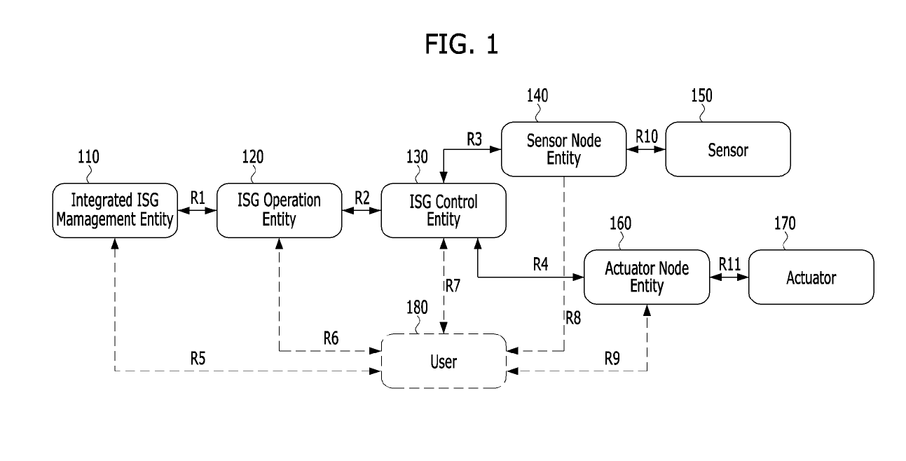

FIG. 1 is a block diagram including elements of an internet of things (IoT)-based smart greenhouse (ISG) according to an embodiment of the present invention.

An integrated ISG management entity 110 illustrated in FIG. 1 corresponds to a server installed outside a greenhouse, while an ISG operation entity 120, an ISG control entity 130, a sensor node entity 140, a sensor 150, an actuator node entity 160, and an actuator 170 are installed inside the greenhouse. In addition, reference numeral 180 in FIG. 1 indicates a user, but may denote a human being or a terminal possessed by the user 180. The terminal corresponds to, for example, a mobile phone, a smart phone, a tablet PC, a notebook or a desktop. The ISG operating entity 120 and the ISG control entity 130 may be implemented as separate elements, as shown in FIG. 1, or may be implemented as a single device which falls within the scope of the present invention.

Further, each of the elements shown in FIG. 1 will be described in more detail below. The integrated ISG management entity 110 collects environmental status information (environmental status values) and provides the ISG operation entity 120 with a target environmental condition. Further, the integrated ISG management entity 110 may maintain a database (DB) including a target crop growth condition so that the target environmental condition may be derived from environmental status information of the greenhouse. The integrated ISG management entity 110 provides the ISG operation entity 120 with the target environmental condition, and, for example, the type of such information corresponds to a profile.

The ISG operation entity 120 receives an environmental status value from the ISG control entity 130 and relays the received environmental status value to the integrated ISG management entity 110. In addition, the ISG operation entity 120 provides the ISG control entity 130 with a target environmental condition.

The ISG control entity 130 receives the environmental status value from the sensor node entity 140 and relays the received environmental status value to the ISG operation entity 120. In addition, the ISG control entity 130 receives a target environmental condition for the greenhouse from the ISG operation entity 120 and sends the actuator node entity 160 a control command according to a sensed environment value.

The sensor node entity 140 senses an environmental status of the greenhouse through the sensor 150 and transmits a sensed value thereof to the ISG control entity 130.

The actuator node entity 160 operates the actuator 170 according to the control command (for example, a command for turning on a ventilator) which is received from the ISG control entity 130.

The user 180 or a device thereof may interact with the above described entities for information interoperation.

Interfaces R1 to R11 between each of the entities may be repeatedly executed by a person skilled in the art through a modeling process, which will be described below with reference to the drawings.

Meanwhile, the entities illustrated in FIG. 1 may correspond to IoT devices installed in an ISG, and the IoT corresponds to an infrastructure that enables services through interconnection between objects on the basis of a communicator capable of information interoperation.

In addition, the device or IoT device described in the present specification corresponds to equipment provided with the ability to perform sensing, actuating, data capturing, data storing or data processing with respect to the IoT. In more detail, the equipment provided with the ability to perform sensing corresponds to the sensor node entity 140 or the sensor 150 illustrated in FIG. 1, the equipment provided with the ability to perform actuation corresponds to the actuator node entity 160 or the actuator 170 illustrated in FIG. 1, and the equipment provided with the ability to perform data capturing/storing/processing corresponds to the ISG control entity 130 illustrated in FIG. 1.

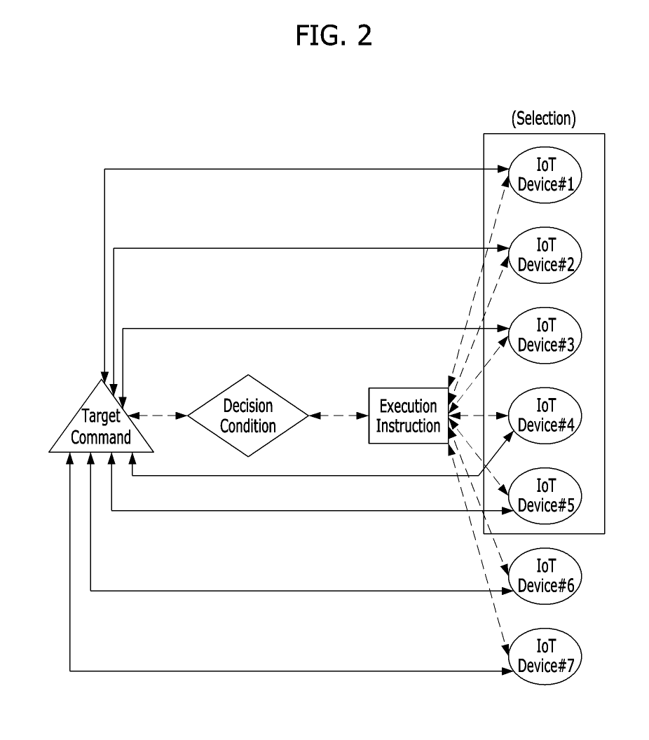

However, there is a need for an algorithm that may derive an optimized crop cultivation environment not only in consideration of actual physically existing entities shown in FIG. 1 but also in consideration of virtual values. Such a modeling process will be described with reference to FIG. 2 to FIG. 7 in detail.

“Selection” Procedure in the Modeling Process

FIG. 2 is a detailed view illustrating a “selection” procedure in a modeling process according to an embodiment of the present invention. Although this procedure is referred to as a selection procedure in this specification, the scope of the present invention is not limited by the term.

First, elements considered in the modeling process shown in FIG. 2 will be described.

A target command shown in FIG. 2 may include at least one of an object to be controlled (a control object) (e.g., a temperature, a humidity, a wind direction, a carbon emission, and the like), a target value (e.g., degrees, percentages, liters, and the like), a time set to reach the target value (e.g., less than one hour, less than two hours, and the like), and a duration of the target value (e.g., for one week, for one month).

Meanwhile, according to another embodiment, the target command includes the control object and the target value, and optionally includes the time set to reach the target value and the duration of the target value. When information about the time set to reach the target value and the duration of the target value are not received, the modeling process is designed to refer to a memory and use a default value.

According to another embodiment, the target command may not include detailed values of the control object and the target value, but may be determined to be mapped with an additional mode. For example, when an optimum growth mode and an environmentally friendly mode are determined, the control object and the target value may be automatically determined to be mapped with each of the modes by referring to the DB. The DB may be stored in a memory in one of IoT devices in the greenhouse, or may be extracted from an external server outside the greenhouse. A decision condition illustrated in FIG. 2 includes at least one of a minimum time, a maximum time, a minimum cost, a maximum cost, a threshold, an order of priority (e.g., selected by a user or automatically), and an environmental value (e.g., an amount of carbon emission, electromagnetic waves, noise, trash, and the like) as a selection condition of a device to execute the target command.

An execution instruction illustrated in FIG. 2 includes details of an instruction that a particular device or IoT device be operated with a certain value during a certain period.

The at least one IoT device illustrated in FIG. 2 does not only operate according to the execution instruction, but also serves to store at least one of profile information, operational status information and capability information of the device, and transmit the stored information when a request is received from an external device.

Meanwhile, the selection procedure is described in more detail with reference to the above described elements shown in FIG. 2.

When the target command includes a particular temperature (e.g. 18° C.) as a target value, at least one device having an influence on the temperature is designed to be selected on the basis of additional information (e.g., profile information, capability information, and operational status information) received from a device connected capable of being communicated.

The profile information includes at least one of a device name, a device ID, a device location, and a category, the capability information includes at least one of a name of a performable task, a processing time of a particular task, and a processing cost of a particular task, and the operational status information includes at least one of a current status of operation of a device, a current availability of a device, a currently executed task, and an expected ending time of the currently executed task.

In particular, the category included in the profile information among the additional information is designed to identify a device having an influence on the temperature. Also, the scope of the present invention includes designing the category to be included in the capability information rather than in the profile information among the additional information.

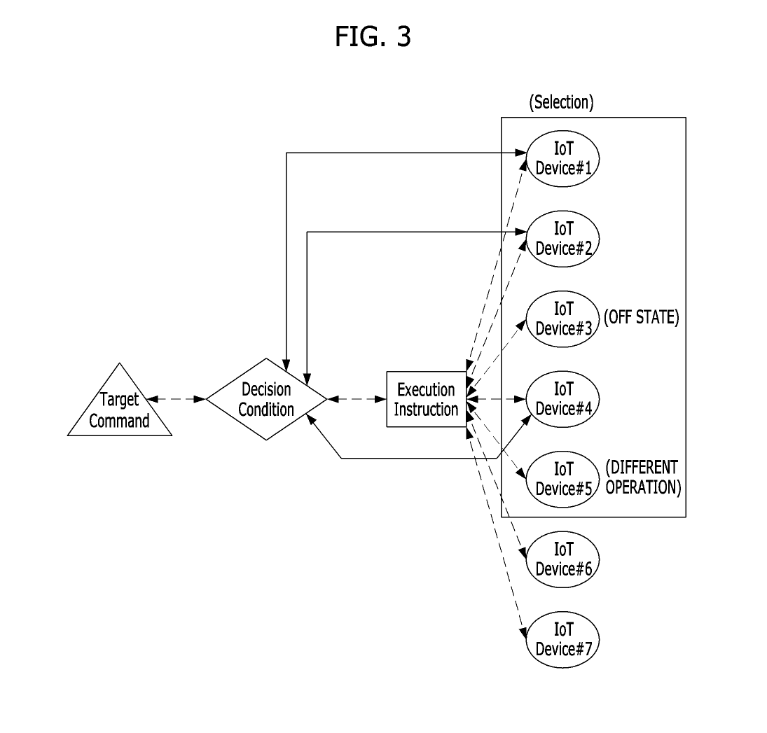

FIG. 2 is illustrated under the assumption that first to fifth IoT devices are selected as devices having a category corresponding to a target object (for example, a temperature) included in the target command, and FIGS. 3 to 7 are also illustrated under the assumption that the first to fifth IoT devices are selected.

“Grouping” Procedure in the Modeling Process

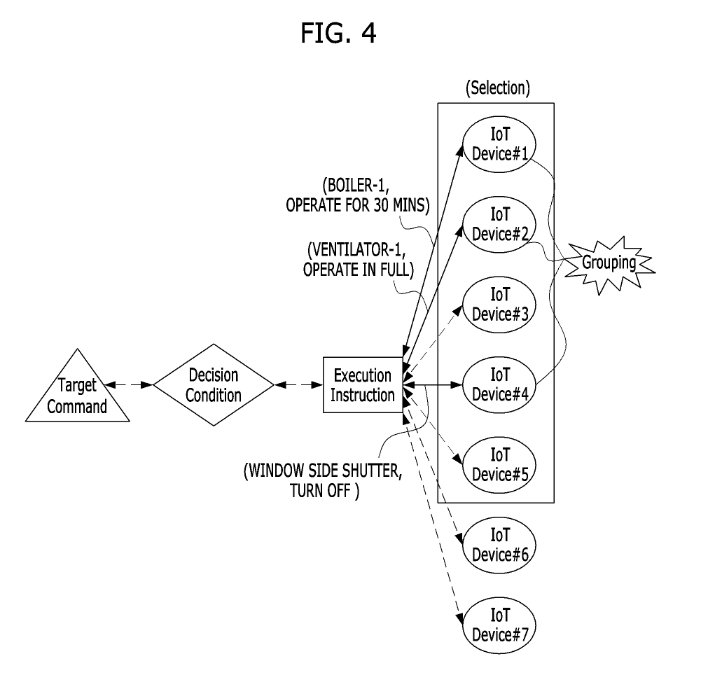

FIGS. 3 and 4 are detailed diagrams illustrating a “grouping” procedure in the modeling process according to an embodiment of the present invention.

After the first to fifth IoT devices having an influence on the temperature are selected in the selection procedure, as shown in FIG. 2, a procedure is needed to determine an object to which an execution instruction will be transmitted among the selected plurality of devices and determine a value. The procedure will be described in detail later with reference to FIGS. 3 and 4. Meanwhile, although this procedure is referred to as a grouping procedure, the scope of the present invention is not limited by the term.

First, a decision condition illustrated in FIG. 3 may be one of various approaches to implement the target command. In more detail, for example, the decision condition includes “range of costs,” “range of power consumption,” “threshold (e.g. a condition of not exceeding 100° C. in any case),” “order of priority (an automatic or manual setting to primarily control a device having no malfunction and secondarily control a device frequently having a malfunction),” and the like as detailed conditions for implementing a target command to maintain 18° C. for one month. In addition, the scope of the present invention may include a decision condition constituted of one or two or more conditions in combination thereof.

Further, referring to FIG. 3, the first IoT device, the second IoT device, and the fourth IoT device may be primarily grouped among the selected first to fifth IoT devices as three particular IoT devices according to the decision condition. In this case, the third IoT device in an off state and the fifth IoT device performing another operation are excluded from the grouping shown in FIG. 3. Such excluding is achieved by receiving additional information from each of the IoT devices in the selection process, as described above.

Meanwhile, when the minimum cost is determined as the decision condition, execution instructions to implement the target command of “18° C.” with the decision condition “minimum cost” are transmitted to each of the first IoT device, the second IoT device, and the fourth IoT device grouped, as shown in FIG. 4. For example, the grouped first IoT device (e.g., a boiler-1) is given an execution instruction to operate for 30 minutes, the grouped second IoT device (e.g., a ventilator-1) is given an execution instruction to operate in full, and the grouped fourth IoT device (e.g., a window side shutter-1) is given an execution instruction to turn off.

“Regrouping” Procedure in the Modeling Process

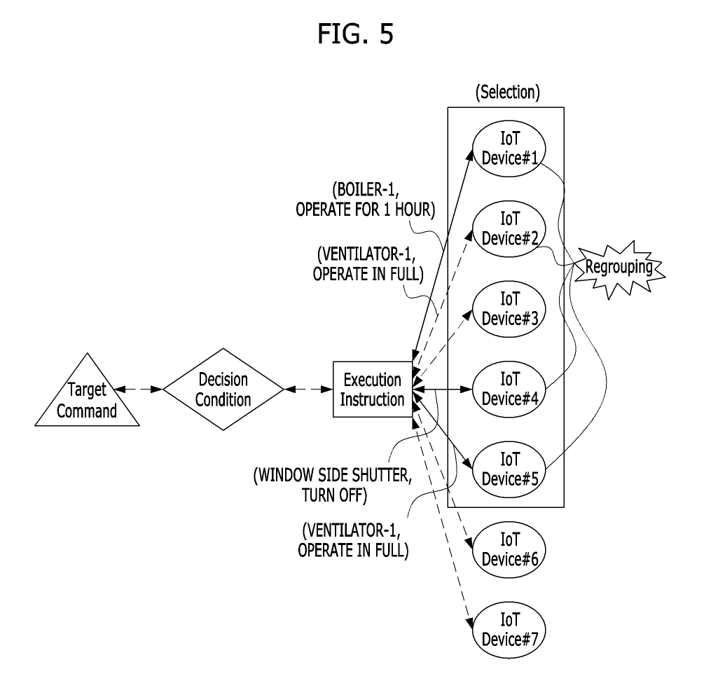

FIG. 5 is a detailed diagram illustrating a “regrouping” procedure in the modeling process according to an embodiment of the present invention. One of the principal features of the present invention includes adaptively implementing regrouping procedure of resetting devices to be controlled and execution instructions by reflecting statuses of IoT devices and decision conditions which may be changed or be the same according to sensing periods. In this specification, for the sake of convenience in description, the term “regrouping” is used, but the scope of the present invention is not limited by the term.

In FIG. 3, the fifth IoT device, which performs the other operation, has been intentionally excluded from the grouping. However, referring to FIG. 5, when the fifth IoT device completes the other operation and a decision condition “there is enough time to satisfy at least one of the time set to reach the target value and the duration of the target value” is added to the decision condition determined to be the minimum cost so that the fifth IoT device is more suitable for the target condition than the second IoT device, an execution instruction to operate for one hour is transmitted to the fifth IoT device (e.g., a ventilator-2), unlike the grouping shown in FIG. 4.

Meanwhile, the resource allocation method for cooperation between IoT devices installed in an ISG will be summarized and described below with reference to FIGS. 1 to 5.

First, the ISG operation entity 120 or the ISG control entity 130 shown in FIG. 1 receives a first request message related to a target command and receives a second request message related to a decision condition at a first point of time.

The first request message or the second request message may be implemented with a single message or separate messages.

Further, the first request message or the second request message may be received directly from other IoT devices or may be extracted from a DB stored in a memory. The DB stored in the memory is constructed in the ISG operation entity 120, the ISG control entity 130, or an external server.

The target command includes at least one of a control object, a target value, a time set to reach the target value, and a duration of the target value, and the decision condition includes at least one of a minimum time, a maximum time, a minimum cost, a maximum cost, a threshold, and an order of priority as a selection condition of a device to execute the target command.

Further, the ISG operation entity 120 or the ISG control entity 130 illustrated in FIG. 1 selects at least one particular device according to information included in the received first request message. The selection procedure has been described in detail with reference to FIG. 2, and those skilled in the art may repeat implementation of the selection procedure with reference to the above.

In addition, the ISG operation entity 120 or the ISG control entity 130 illustrated in FIG. 1 receives at least one of profile information, capability information, and operational status information from the selected at least one particular device at a second point of time, and performs grouping on the at least one device according to the decision condition included in the second request message received at the first point of time and at least one of the profile information, capability information, and operational status information received at the second point of time. The grouping procedure has been described in detail with reference to FIGS. 3 and 4, and those skilled in the art may repeat implementation of the grouping procedure with reference to the above.

The ISG operation entity 120 or the ISG control entity 130 illustrated in FIG. 1 receives a second request message related to a decision condition at a third point of time (the third point of time is different from the first point of time), and receives at least one profile information, capability information, or operational status information from the selected at least one particular device at a fourth point of time (the fourth point of time different from the second point of time). According to the decision condition included in the second request message received at the third point of time (or, unless the second request message is received at the third point of time, at the first point of time), and at least one of the profile information, capability information, and operational status information received at the fourth point of time (or, unless the information is received at the fourth point of time, at the second point of time), the at least one device is regrouped. The regrouping procedure has been described in detail with reference to FIG. 5, and those skilled in the art may repeat implementation of the regrouping procedure with reference the above.

According to an embodiment of the present invention, the second request message used in the regrouping procedure may be the same as the second request message used in the grouping stage or may be a different message received at a different point of time. Accordingly, the present invention may be applied even in a case in which a decision condition used in the grouping stage is different from a decision condition used in the regrouping stage.

In more detail, for example, the decision condition is used according to an order of priority which may be set by a user or automatically generated in the grouping stage, but the order of priority may be changed in the regrouping stage (for example, upon a failure to satisfy the target command to reach the temperature of 18° C. within one hour, a decision condition for satisfying the target command within a minimum time is newly calculated regardless of the order of priority used in the grouping).

The decision condition is one of various approaches to implement the target command. For example, the decision condition includes at least one of a range of costs, a range of power consumption, a threshold, a minimum/maximum time, a minimum/maximum cost, a shipment time, an order of priority (set to primarily control a device having no malfunction and secondarily control a device frequently having a malfunction), and the like as a detailed condition for selecting a device to implement a target command.

Describing the selection procedure again, when the target command includes a particular temperature (18° C.) as a target value, at least one device having an influence on the temperature is selected on the basis of profile information, capability information, and operational status information received from a device connected capable of being communicated.

Describing the grouping procedure again, when the decision condition with respect to the target command (18° C.) is “minimum cost,” execution instructions to implement the target command with the decision condition are transmitted to each of devices grouped with the decision condition among devices selected as having an influence on the temperature, for example, the grouped first IoT device (e.g., the boiler-1) is given an execution instruction to operate for 30 minutes, the grouped second IoT device (e.g., the ventilator-1) is given an execution instruction to operate in full, and the grouped fourth IoT device (e.g., the window side shutter-1) is given an execution instruction to turn off.

Describing the regrouping procedure again, a decision condition received at a different point of time or having an additional decision condition added thereto is reflected so that when a device more suitable for the decision condition exists, for example, an execution instruction to operate for one hour is transmitted to the fifth IoT device (e.g., the ventilator-2), unlike the above-described grouping.

The grouping and the regrouping determine an operation ratio and operation order of each device selected to implement the target command among a plurality of devices in consideration of a selection condition (a decision condition to implement a target command).

That is, the present invention not only performs an action of an execution instruction for satisfying a growth condition received from the external DB in a dependent manner or setting a control condition of a single device, but also determines orders of priority or operation ratios of devices to satisfy a target command by reflecting a decision condition which is changed depending on a status of the satisfaction of the growth condition received from the external DB or depending on a user's setting so that control efficiency or reliability for implementing the target command is increased.

In addition, even for the same device, under specifications of a greenhouse currently to be controlled (for example, with a difference in volume and material of a greenhouse or an actuator included in the greenhouse), a capacity or cost of the actuator is calculated, thereby ensuring calculation and application of greenhouse-specific capability information.

That is, for a target command to maintain a particular temperature and a decision condition thereof (operation requirements, for example, minimizing costs or adjusting a shipping date), a capability or cost of an actuator is calculated and used as a basis to determine whether to drive a device.

For example, the calculation and application of greenhouse-specific capability information may be ensured by calculating an operation time and cost required to increase 1° C. Even for the same boiler, the time and cost required to increase 1° C. may vary depending on the greenhouse in which the boiler is disposed (differing in volume between a greenhouse-A and a greenhouse-B). Based on a result of calculating greenhouse-specific—actuator capability information, expected required times and costs of actuators to satisfy the target command may be adaptively calculated to correspond to a circumstance of a particular greenhouse.

In addition, when the decision condition includes an adjustment of a shipment date, the greenhouse-specific actuator capability information is calculated and is provided to a farmer as reference for the farmer to refer to when making a decision to appropriately adjust an input cost, thereby aiding the farmer to exactly recognize the cost of harvesting a crop at a particular time when making a decision.

For example, it may be assumed that, according to the current target command, a harvest is conducted three weeks from the present.

In this case, when the harvest time is two weeks from the present, that is, an expected harvest time is advanced one week from the original harvest time in consideration of market conditions, an additional cost is incurred by advancing the harvest time.

However, when income generated by advancing the harvest time one week is expected to be greater than the cost incurred by advancing the harvest time one week (i.e, the income from harvesting two weeks from the present−the cost additionally incurred by advancing the harvest time>the income from harvesting three weeks from the present−the cost required to currently satisfy the target command), it may be determined that the harvest time should be advanced one week, and, as a basis for making such a decision, adaptive calculation material is provided.

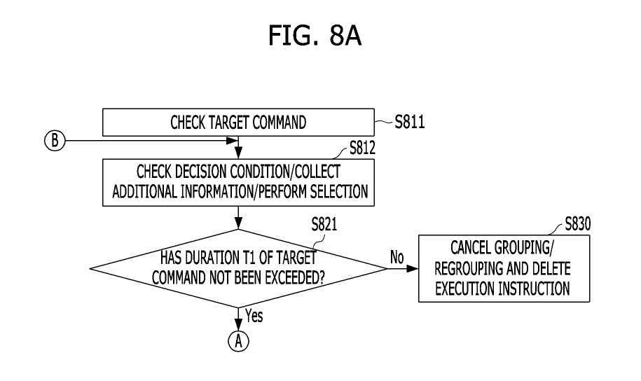

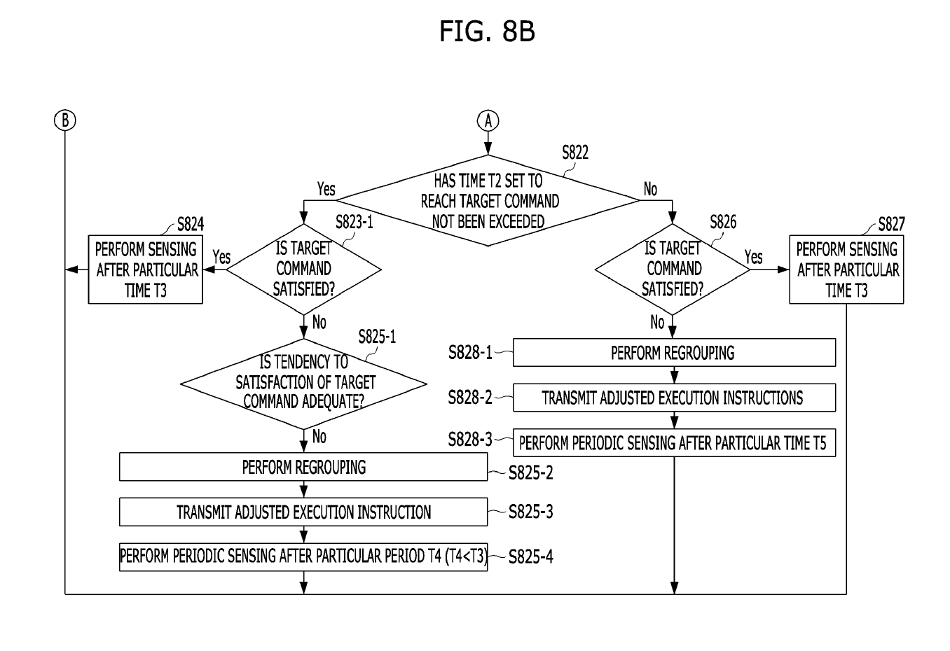

A trigger condition for orders of operation priority or operation ratios of a plurality of devices will be described later with reference to FIG. 8A and FIG. 8B.

“Virtual Device” Processing Procedure in the Modeling Process

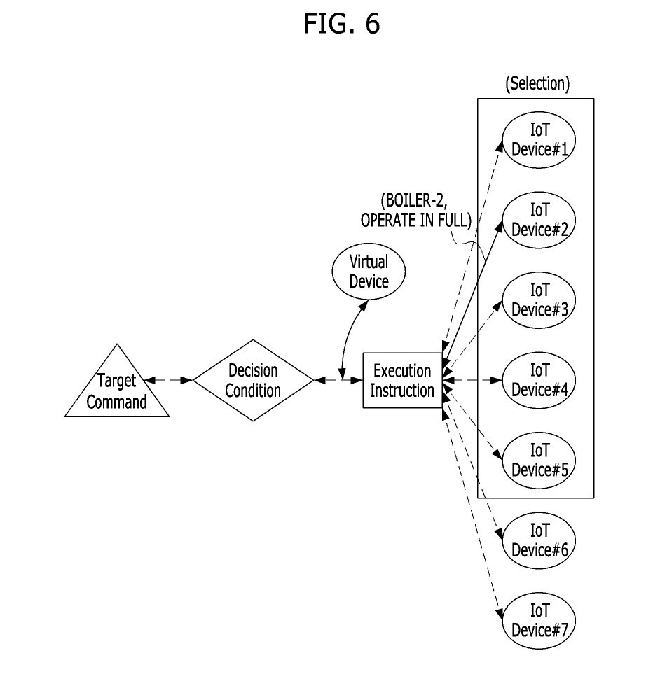

FIG. 6 is a diagram in which a “virtual device” is additionally considered in the modeling process according to an embodiment of the present invention. The scope of the present invention includes additionally analyzing FIG. 6 in conjunction with the preceding drawings.

A virtual device illustrated in FIG. 6 does not refer to an IoT device currently physically existing in a greenhouse, but refers to a virtual element that may influence at least one of a decision condition and an execution instruction.

Further, the virtual device includes at least one of independent information independent of a value processed by the IoT device in the greenhouse and dependent information dependent on the value processed by the IoT device in the greenhouse.

The independent information included in the virtual device may be a predicted temperature of the inside of the greenhouse, and a current temperature or predicted temperature of the outside of the greenhouse. In more detail, for example, regardless of a temperature sensed by the IoT device in the greenhouse, the current temperature or predicted temperature of the outside of the greenhouse may be received by the ISG operation entity 120 or the ISG control entity 130 from an external server.

Meanwhile, the dependent information included in the virtual device will be described below. For example, when raw data captured by a camera, which is an example of the IoT device in the greenhouse, is transmitted to an external server, a result value defining a status of a crop in the greenhouse (e.g., whether a harmful insect is present) according to an analysis algorithm of the external server is transmitted to the ISG operation entity 120 or the ISG control entity 130. The result value is an example of the dependent information included in the virtual device.

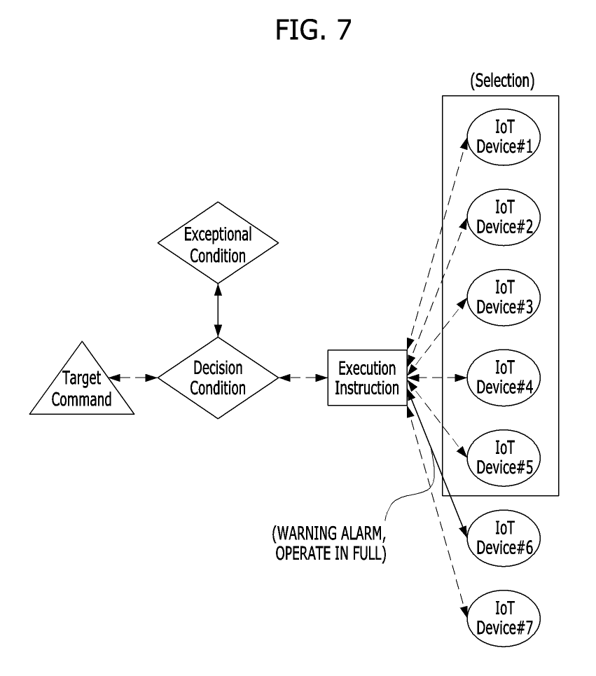

According to the independent information or dependent information included in the virtual device, an exceptional condition is derived. For example, the exceptional condition (e.g., an abrupt change in temperature) is estimated according to the current temperature or predicted temperature of the outside of the greenhouse, which is an example of the virtual device. Further, the exceptional condition (e.g., whether a harmful insect is present) is estimated according to the result value defining the status of the crop in the greenhouse, which is another example of the virtual device. The processing process of the exceptional condition will be described in detail below with reference to FIG. 7.

In more detail, for example, the virtual device corresponds to the predicted temperature of the inside of the greenhouse, the current temperature of the outside of the greenhouse, and the predicted temperature of the outside of the greenhouse. The predicted temperature of the inside of the greenhouse, and the current/predicted temperature of the outside of the greenhouse may be information obtained through the integrated ISG management entity 110 or a server (external virtual device).

In more detail, for example, when intense cold is expected due to heavy snow outside the greenhouse, the virtual device illustrated in FIG. 6 transmits an execution instruction to the second IoT device (e.g., a boiler-2), which has a good performance, to operate in full. This is a result different from that shown in the initial grouping and regrouping described above with reference to FIGS. 2 to 7.

Meanwhile, adding to the description with reference to FIG. 1, the ISG operation entity 120 or the ISG control entity 130 illustrated in FIG. 1 receives a third request message related to the virtual device illustrated in FIG. 6. As described above, the virtual device includes information obtained through the integrated ISG management entity 110 or a server, that is, includes an external virtual device.

The ISG operation entity 120 or the ISG control entity 130 illustrated in FIG. 1 performs grouping or regrouping on the at least one device according to the information included in the received third request message, the information included in the received second request message, and at least one of the received profile information, capability information, and operational status information.

“Exceptional Condition” Processing Procedure in the Modeling Process

FIG. 7 is a diagram in which a “exceptional condition” is additionally considered in the modeling process according to an embodiment of the present invention.

The exceptional condition illustrated in FIG. 7 refers to an emergency, and more specifically includes at least one of damage to a facility in the greenhouse or to the greenhouse itself, an occurrence of intrusion into the greenhouse, occurrence of fire, an abrupt climate change, and an occurrence of an earthquake. Meanwhile, although the exceptional condition is illustrated as another concept having the same level as that of the decision condition in FIG. 7, the exceptional condition may be designed as an alternative included in the decision condition.

Meanwhile, adding to the description with reference to FIG. 1, when the exception condition (e.g., the emergency) is included in the decision condition, the ISG operation entity 120 or the ISG control entity 130 illustrated in FIG. 1 cancels the operation of selecting at least one particular device according to the information included in the received first request message and sends an execution instruction to a sixth IoT device (e.g., a warning alarm), which is more suitable for the emergency, to operate the sixth IoT device in full.

The preceding drawings have been illustrated in the context of the elements required for the modeling process and the embodiments corresponding thereto. However, FIG. 8A and FIG. 8B are illustrated in the context of operations according to a time sequence.

FIG. 8A and FIG. 8B are main flowcharts showing an overall modeling process with reference to FIGS. 2 to 7. A subject of performing the operations illustrated in FIG. 8A and FIG. 8B may be a certain device illustrated in FIG. 1.

However, the following description will be made under the assumption that the operations are performed by the ISG operation entity 120 or the ISG control entity 130 illustrated in FIG. 1.

First, referring to FIG. 8A, the ISG operation entity 120 or the ISG control entity 130 illustrated in FIG. 1 checks a target command (S811), checks a decision condition, collects additional information, and performs selection on devices (S812).

For the sake of convenience in description, the target command is assumed to be a command to change a temperature in a greenhouse to 18° C.

Since a control object is the temperature, a list of devices to be controlled with regard to the temperature is selected. For example, a boiler, a ventilator, a ridge vent, and a side vent may be included in the list of devices.

Further, additional information about each of the devices is collected. The additional information includes at least one of profile information, operational status information, and capability information of each of the devices, as described above. The profile information includes information about a position of the device, information about the number of devices, and information about an influence exerted on one device by another device. In more detail, for example, when two ventilators exist, a time taken for a ventilator-1 to increase a temperature in a particular area by 1° C., a cost thereof, and the amount of trash discarded therefor are included in the additional information.

Then, referring to FIG. 8A and FIG. 8B, the ISG operation entity 120 or the ISG control entity 130 illustrated in FIG. 1 repeatedly or periodically checks whether the target command is satisfied. It is necessary to define time information for triggering operation of the regrouping described with reference to FIG. 5. Then, the ISG operation entity 120 or the ISG control entity 130 illustrated in FIG. 1 adjusts the execution instruction according to the decision condition and the device additional information. An initially generated execution instruction corresponds to the grouping, and an execution instruction newly generated at a certain point of time after the initial generation of the execution instruction corresponds to the regrouping.

For example, weighted ratios and detailed execution instructions of devices for implementing the target command are adjusted in consideration of a preference, which is an example of data included in the decision condition. In more detailed, for example, a time (e.g., within one hour), a cost (e.g., 1,000 dollars or less), an environment (e.g., an allowable amount of carbon emission), and the like may be considered.

For example, the weighted ratios and detailed execution instructions of devices for implementing the target command are adjusted in consideration of a threshold, which is another example of data included in the decision condition. In more detail, for example, a minimum time, a maximum time, a minimum cost, a maximum cost, environmentally friendly, and the like may be considered.

For example, the weighted rations and detailed execution instructions of devices for implementing the target command are adjusted in consideration of an order of priority or user's demand, which is another example of data included in the decision condition. In more detail, according to the order of priority or the user's demand, a particular boiler (a new product having no chance of malfunction) is operated with the top priority regardless of other conditions, whereas a boiler (an old boiler or a boiler having a high chance of malfunction) is operated with the last priority.

Accordingly, information indicating that a cost x2 is incurred and an amount of environmental waste x3 is generated when a boiler-1 is operated for a time x1, information indicating that a cost y2 is incurred and an amount of environmental waste y3 is generated when a ventiator-1 is operated for a time y1, and information indicating that a cost z2 is incurred and an amount of environmental waste z3 is generated when a ridge vent-1 is operated for a time z1 is previously stored in the DB.

According to the present invention, even with the same decision condition, it is necessary to adjust the execution instruction according to a time at which a status of satisfaction of the target command is checked and/or depending on whether the target command being satisfied. The resource allocation method devised due to such a need is described in detail with reference to FIG. 8A and FIG. 8B.

The ISG operation entity 120 or the ISG control entity 130 illustrated in FIG. 1 determines whether a duration T1 of the target command is not exceeded (S821), and when the duration T1 of the target command is exceeded, performs a cancellation of the grouping/regrouping and a deletion of the execution instruction (S830).

When that the duration T1 of the target command is not exceeded as a result of the determination in the operation of S821, it is determined whether a time T2 set to reach the target command is not exceeded (S822). In this case, the time T2 is set to be smaller than the duration T1.

For example, the duration T1 of the target command is time information for maintaining the greenhouse at the temperature of 18° C. “for one month,” and the time T2 set to reach the target command is time information for limiting a time taken to reach and initially maintain the temperature of 18° C. to “10 hours or less.”

When the time T2 set to reach the target command is not exceeded as a result of the determination in the operation S822, it is determined whether the target command is satisfied (S823-1).

When the target command is satisfied as a result of the determination in the operation S823-1, the ISG operation entity 120 or the ISG control entity 130 is designed to monitor (sense) whether the target value is satisfied after an elapse of a particular time T3 (S824).

The operation S824 includes setting a period for performing the operation S823-1 of determining whether the target command is satisfied. For example, when the time set to reach the target command is ten hours, whether the target command is satisfied is determined at periods corresponding to a point of time t3-1 when five hours elapses, a point of time t3-2 when two and a half hours elapses from the point of time t3-1, and a point of time t3-3 when one hour and fifteen minutes elapses from the point of time t3-2.

In the case of an environment in which a special crop, which is a high value-added crop, is grown, when requiring the target condition to be quickly satisfied in an initial stage of control is necessary even though additional cost is incurred, the time for checking whether the target command is satisfied may be set to be arbitrarily adjusted such that satisfaction is checked for every hour or every 30 minutes.

After the operation S824, the operation S812 resumes. That is, when the target value is already satisfied, periodic monitoring is not immediately performed, thereby reducing an unnecessary waste of resources.

According to the particular time T3, whether the target value is satisfied is sensed at time intervals according to a preset scheme. The preset scheme is classified into a scheme i) of equally dividing the time intervals in a fixed scheme, a scheme ii) of dividing the time intervals to decrease with regularity and converge, or a scheme iii) of randomly dividing the time intervals in a variable scheme.

For the scheme ii), the particular time T3 may include periods of time intervals t3-1, t3-2, t3-3, and the like, in which each of the intervals t3-1, t3-2, t3-3, and the like may be reduced, for example, by ½ a preceding interval thereof to converge for sensing.

$$( {t}_{n} = \frac{1}{2} {t}_{n - 1} )$$

For the scheme iii), the time interval may be randomly designated by a farmer, a greenhouse installer, an external control manager, or the like.

Meanwhile, when the target command is not satisfied as a result of the determination in the operation S823-1, it is determined that a device execution instruction is needed depending on whether a tendency to a satisfaction of the target command is adequate (S825-1).

For example, it may be assumed that a current point of time, at which whether the target command is satisfied is checked, is applied to the determination of the need to adjust the execution instruction. When the time set to reach the target command is ten hours, as described above, and the point of time at which whether the target command is satisfied is checked is after five hours elapses, it is determined that the execution instruction does not need to be adjusted in the operation S825-1, and thus an operation S825-4 is performed.

Meanwhile, when the time set to reach the target command is ten hours, as described above, and the point of time at which whether the target command is satisfied is checked is after seven and a half hours elapses, it is determined that it is necessary for the execution instruction to be adjusted in the operation S825-1, and thus operations S825-2 an S825-3 are performed.

A criterion for the determination in the operation S825-1 may be implemented not only by a temporal factor shown in the above assumption, but also by an external DB or a user's input signal according to the characteristics of the growing crop, as described above.

To aid those skilled in the art in the understanding of the present invention, a target command received at 1:00 pm on Jun. 1, 2017 is assumed to have a duration maintaining 18° C. of one month and a time set to reach 18° C. of ten hours.

Grouping is assumed to be performed according to the target command and the decision condition such that a boiler, a ventilator, and a ceiling opening/closing device are selected among temperature related IoT devices, and between a boiler-1 and a boiler-2 1, the boiler-1 having a lower cost is selected, and between a ventilator-1 and a ventilator-2, the ventilator-1 is selected, and the ceiling opening/closing device is half turned off.

A time 3:00 pm on Jun. 1, 2017 is included within the duration of the target command and also within the time set to reach the target command. Whether the target command is satisfied is determined (S823-1), and when the target command is satisfied, sensing is not performed immediately but performed after the particular time T3 elapses (S824), thereby preventing an unnecessary waste of sensing resources.

Meanwhile, when the target command is determined to not be satisfied as a result of the determination in the operation S823-1, whether a tendency to satisfaction of the target command is adequate is checked to determine the necessity of adjusting the execution instruction (S825-1).

That is, since five hours of the time set to reach the target command of the ten hours pass, the tendency to satisfaction needs to arithmetically be 50%. However, when the tendency to satisfaction remains at 30%, the execution instruction is adjusted to perform regrouping (S825-2).

Subsequently, the adjusted execution instruction is transmitted to the devices (S825-3) to completely turn off the boiler-2, the ventilator-2, and the ceiling opening/closing device which have been excluded among the IoT devices.

Then, continuous sensing is performed with a sensing period T4 which is set to be shorter than the particular time T3 serving as a criterion for performing the sensing when the target command is satisfied (S825-4).

According to the sensing period T4, whether the target value is satisfied is sensed at time intervals according to a preset scheme. The preset scheme is classified into the scheme i) of equally dividing the time intervals in a fixed scheme, the scheme ii) of dividing the time intervals to decrease with regularity and converge, or the scheme iii) of randomly dividing the time intervals in a variable scheme.

For the scheme ii), the sensing period T4 include periods of time intervals t4-1, t4-2, t4-3, and the like, and each of the intervals t4-1, t4-2, t4-3, and the like may be reduced, for example, by ½ a preceding interval thereof to converge for sensing.

$$( {t}_{n} = \frac{1}{2} {t}_{n - 1} )$$

For the scheme iii), the time interval may be randomly designated by a farmer, a greenhouse installer, an external control manager, or the like.

In the relation between the particular time T3 and the sensing period T4, the time intervals t3-1, t3-2, t3-3, and the like are larger than the time intervals t4-1, t4-2, t4-3, and the like.

When the time T2 set to reach the target command is exceeded as a result of the determination in the operation S822, whether the target command is satisfied is determined (S826). When the target command is satisfied as a result of the determination in the operation S826, the ISG operation entity 120 or the ISG control entity 130 is designed to monitor (sense) whether the target value is satisfied after the predetermined time T3 elapses (S827). After the operation S827, the operation S812 is resumed to check a decision condition, collect additional information, and perform a selection. That is, since the target value is already satisfied, similar to the above-described operation S824, periodic monitoring is not performed immediately, thereby reducing an unnecessary waste of resources.

Meanwhile, when the target command is not satisfied as a result of the determination in the operation S826 (for example, when the target command is not satisfied after the time set to reach the target command passes due to a decrease in an outdoor temperature caused by an abrupt climate change), it is necessary to adjust execution instructions of the devices. Accordingly, the execution instructions are adjusted to perform regrouping (S828-1). Then, the adjusted execution instructions are transmitted to the devices (S828-2), and continuous sensing is performed with a sensing period T5 which is set to be shorter than the sensing period T3 used when the target command is satisfied (S828-3).

According to the sensing period T5, whether the target value is satisfied is sensed at time intervals according to a preset scheme. The preset scheme is classified into the scheme i) of equally dividing the time intervals in a fixed scheme, the scheme ii) of dividing the time intervals to decrease with regularity and converge, or the scheme iii) of randomly dividing the time intervals in a variable scheme.

For the scheme ii), the sensing period T5 includes periods of time intervals t5-1, t5-2, t5-3, and the like, and each of the intervals t5-1, t5-2, t5-3, and the like may be reduced, for example, by ½ a preceding interval thereof to converge for sensing.

$$( {t}_{n} = \frac{1}{2} {t}_{n - 1} )$$

For the scheme iii), the time interval may be randomly designated by a farmer, a greenhouse installer, an external control manager, or the like.

In the relation between the sensing period T5 and the particular time T3 described above, the time intervals t5-1, t5-2, t5-3, and the like are smaller than the time intervals t3-1, t3-2, t3-3, and the like.

The sensing period T5 is shorter than the period T3 described above, and is independent of the sensing period T4.

One of the IoT devices (e.g., the ISG operation entity 120 or the ISG control entity 130 illustrated in FIG. 1) may obtain the above-described decision condition received from another external IoT device or extracted from the memory.

Further, grouping is performed according to the decision condition and the device additional information in the operation S812. As described above with reference to FIGS. 3 and 4, the grouping corresponds to a process of generating an execution instruction including both “device to be controlled” and “setting value for each device.”

The cooperation method between IoT devices installed in an ISG which is another embodiment of the present invention, may be summarized as follows.

One of IoT devices (e.g., the ISG operation entity 120 or the ISG control entity 130 illustrated in FIG. 1) processes data related to a target command and data related to a decision condition, and selects at least one particular device according to the processed target command related data. The selection procedure has been described above in detail with reference to FIG. 2.

The one of the IoT devices (e.g., the ISG operation entity 120 or the ISG control entity 130 illustrated in FIG. 1) performs grouping on at least one device according to additional information received from the selected at least one particular device and the processed decision condition related data, and transmits a first execution instruction to each of the grouped at least one device. The grouping procedure has been described above in detail with reference to FIGS. 3 and 4.

The one of the IoT devices (e.g., the ISG operation entity 120 or the ISG control entity 130 illustrated in FIG. 1) performs regrouping on the at least one device according to additional information newly received from the selected at least one particular device after the grouping and the processed decision condition related data, and transmits a second execution instruction to each of the regrouped at least one device. The regrouping procedure has been described above in detail with reference to FIG. 5.

Meanwhile, the first execution instruction and the second execution instruction are different in terms of at least one of content and a received object. For example, the first execution instruction includes a one-level temperature control for a first device, a two-level temperature control for a second device, and an off-control for a fourth device, while the second execution instruction merely includes a two-level temperature control for the first device and an on-control for the fourth device. That is, the received object corresponds to a device that receives an execution instruction, and the content corresponds to an actual control command (e.g., a one-level temperature control, a two-level temperature control, and the like).

According to an embodiment of the present invention, the one of the IoT devices (e.g., the ISG operation entity 120 or the ISG control entity 130 illustrated in FIG. 1) determines whether a target value is satisfied within a preset duration according to the processed target command related data, changes a sensing period depending on whether the target value is satisfied, and repeats the regrouping according to the changed sensing period.

According to another embodiment of the present invention, the one of the IoT devices (e.g., the ISG operation entity 120 or the ISG control entity 130 illustrated in FIG. 1) determines whether a target value is satisfied within a preset duration according to the processed target command related data, changes a sensing period depending on whether the target value is satisfied, determines whether the target command is satisfied according to the changed sensing period, and repeats the regrouping depending on whether the target command is satisfied.

In more detail, for example, when the duration T1 of the target command is not exceeded, whether the time T2 set to reach the target command is not exceeded is determined (the duration T1 is larger than the time T2). When the target value is satisfied, the one of the IoT devices is controlled to perform sensing after the particular time T3 elapses, and when the target value is not satisfied, the one of the IoT devices is controlled to perform sensing with the sensing period T4 (the sensing period T4 is smaller than the particular time T3).

That is, whether the duration T1 of the target command is not exceeded and the time T2 set to reach the target command is not exceeded is determined, and, when the target command is satisfied, whether the target value is satisfied is sensed after the particular time T3 elapses is determined. Meanwhile, when the target command is not satisfied within the time set to reach the target command, an execution instruction is adjusted depending on a result of determining whether a tendency to satisfaction of the target command at a current point of time is adequate so that operation ratios and orders of priority of the devices are adjusted, and periodic sensing is performed with the sensing period T4 shorter than the particular time T3 to determine whether the target command is satisfied.

The advantageous effects of the cooperation method and the resource allocation method for cooperation between IoT devices installed in an ISG according to the present invention are as follows.

As should be apparent from the above, a modeling scheme for the cooperation method and the resource allocation for cooperation between IoT devices installed in an ISG can be provided.

An unnecessary data loss can be prevented and an optimal combination of IoT devices can be determined by defining a trigger condition for starting grouping and regrouping that are required for modeling.

Further, for the sake of convenience in description, the present invention has been described in the context of individual drawings, but the embodiments described in the drawings may be combined and implemented as a new embodiment.

In addition, the construction and method according to the embodiment of the present invention are not intended to limit the present invention to such embodiments. Rather, all or part of each of the embodiments may be selectively combined such that various modifications of the embodiments are possible.

The present invention described above may be embodied as computer-readable code on a program recording medium. The computer-readable medium includes all types of storage devices configured to store data that can be read by a computer system. Examples of the computer-readable medium include a hard disk drive (HDD), a solid-state drive (SSD), a silicon disk drive (SDD), a read-only memory (ROM), a random-access memory (RAM), a compact disc (CD)-ROM, a magnetic tape, a floppy disk, an optical data storage device, and the like. In addition, the computer-readable medium may be implemented in the form of a carrier wave (e.g., transmission through the Internet).

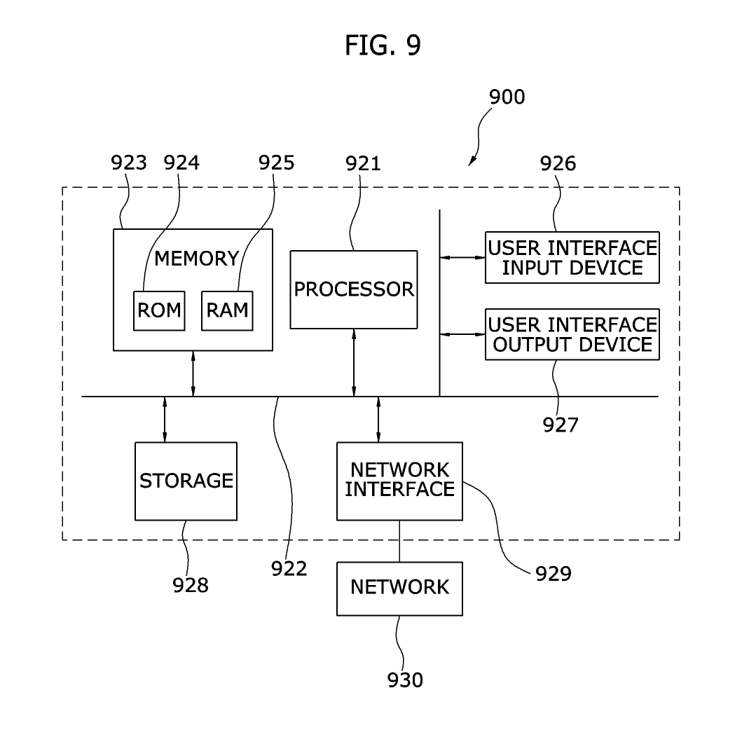

The method according to an embodiment of the present invention may be implemented in a computer system or may be recorded in a recording medium. FIG. 9 illustrates a simple embodiment of a computer system. As illustrated, the computer system may include one or more processors 921, a memory 923, a user input device 926, a data communication bus 922, a user output device 927, a storage 928, and the like. These components perform data communication through the data communication bus 922.

Also, the computer system may further include a network interface 929 coupled to a network. The processor 921 may be a central processing unit (CPU) or a semiconductor device that processes a command stored in the memory 923 and/or the storage 928.

The memory 923 and the storage 928 may include various types of volatile or non-volatile storage mediums. For example, the memory 923 may include a ROM 924 and a RAM 925.

Thus, the method according to an embodiment of the present invention may be implemented as a method that can be executable in the computer system. When the method according to an embodiment of the present invention is performed in the computer system, computer-readable commands may perform the producing method according to the present invention.

The method according to the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

Further, the above description is to be considered illustrative rather than restrictive in all aspects. The scope of the invention is to be interpreted in a sense defined by the appended claims, and the present invention covers all modifications provided they come within the scope of the appended claims and their equivalents.

What is claimed is:

1. A resource allocation method for cooperation between internet of things (IoT) devices installed in an IoT-based smart greenhouse (ISG), comprising:
receiving a first request message related to a target command;
receiving a second request message related to a decision condition at a first point of time;
selecting at least one particular device according to information included in the received first request message;
receiving at least one of profile information, capability information, and operational status information from the selected at least one particular device at a second point of time;
grouping the at least one device according to the decision condition included in the second request message received at the first point of time and the at least one of the profile information, the capability information, and the operational status information received at the second point of time;
receiving a second request message related to a decision condition at a third point of time which is different from the first point of time;
receiving at least one of profile information, capability information, and operational status information from the selected at least one particular device at a fourth point of time which is different from the second point of time; and
regrouping the at least one device according to the decision condition included in the second request message received at the first point of time or the third point of time and the at least one of the profile information, the capability information, and the operational status information received at the second point of time or the fourth point of time.

2. The resource allocation method of claim 1, wherein the second request message used in the regrouping is the same message as the second request message used in the grouping, or is a different message received at a different point of time.

3. The resource allocation method of claim 1, wherein the first request message and the second request message are implemented using a single message or different messages.

4. The resource allocation method of claim 1, wherein the first request message or the second request message is received directly from another IoT device or is extracted through a database (DB) stored in a memory.

5. The resource allocation method of claim 4, wherein the DB stored in the memory is constructed in an ISG operation entity, an ISG control entity, or an external server.

6. The resource allocation method of claim 1, wherein the target command includes at least one of an object desired to be controlled, a target value, a time set to reach the target value, and a duration of the target value.

7. The resource allocation method of claim 6, wherein the decision condition includes at least one of a minimum time, a maximum time, a minimum cost, a maximum cost, a threshold, and an order of priority as a selection condition of a device to execute the target command, and
the grouping and the regrouping include determining an operation rate or an operation order of each device selected to implement the target command among a plurality of devices in consideration of the selection condition.

8. The resource allocation method of claim 1, wherein the profile information includes at least one of a device name, a device ID, a device location, and a category,
the capability information includes at least one of a name of a performable task, a processing time of a particular task, and a processing cost of the particular task, and
the operational status information includes at least one of a current status of an operation of a device, a current availability of the device, a currently executed task, and an expected ending time of the currently executed task.

9. The resource allocation method of claim 7, wherein the decision condition further includes an exceptional condition, and
the resource allocation method further comprises canceling the selecting at least one particular device according to the information included in the received first request message;

10. The resource allocation method of claim 1, further comprising:
receiving a third request message related to a virtual device; and
grouping or regrouping the at least one device according to information included in the received third request message, the information included in the received second request message, and the received at least one of the profile information, the capability information, and the operational status information.

11. A cooperation method between internet of things (IoT) devices installed in an IoT-based smart greenhouse (ISG), comprising:
processing data related to a target command and data related to a decision condition;
selecting at least one particular device according to the processed data related to the target command;
grouping the at least one device according to additional information received from the selected at least one particular device and the processed data related to the decision condition;
transmitting a first execution instruction to each of the grouped at least one device;
regrouping the at least one device according to additional information newly received from the selected at least one particular device and the processed data related to the decision condition or newly received data related to a decision condition after the grouping; and
transmitting a second execution instruction to each of the regrouped at least one device.

12. The cooperation method of claim 11, further comprising:
checking whether the target command is satisfied, wherein whether a duration (T1) of the target command is not exceeded and whether a time (T2) set to reach the target command is not exceeded are checked;
when the target command is satisfied, sensing whether a target value is satisfied after a particular time (T3) elapses; and
when the target command is not satisfied within the time set to reach the target command, readjusting an operation ratio or an order of priority of each of the devices by adjusting an execution instruction according a result of determining whether a tendency to satisfaction of the target command at a current time is adequate, and periodically sensing whether the target command with a sensing period (T4) shorter than the particular time (T3) is satisfied.

13. The cooperation method of claim 12, wherein according to the particular time (T3), whether the target value is satisfied is sensed at time intervals according to a preset scheme, in which the preset scheme includes equally dividing the time intervals in a fixed scheme, dividing the time intervals to decrease with regularity and converge, or randomly dividing the time intervals in a variable scheme.

14. The cooperation method of claim 12, wherein the checking of whether the target command is satisfied includes checking tendency to satisfaction of the target command according to preset period determination information, and applying a weight to readjust the operation ratio or the order of priority on the basis of a current time at which check whether the target command is satisfied is checked.

15. The cooperation method of claim 11, further comprising canceling the grouping or regrouping when the duration of the target command elapses according to the processed date related to the target command.

16. The cooperation method of claim 11, wherein the received additional information includes at least one of profile information, capability information, and operational status information of each device.

17. The cooperation method of claim 11, wherein the first execution instruction and the second execution instruction are different in terms of at least one of content and a received object.

18. The cooperation method of claim 11, wherein the data related to the target command includes at least one of an object desired to be controlled, the target value, a time set to reach the target value, and a duration of the target value.

19. The cooperation method of claim 18, wherein the data related to the decision condition includes at least one of a minimum time, a maximum time, a minimum cost, a maximum cost, a threshold, and the order of priority as a selection condition of a device to execute the target command.

20. The cooperation method of claim 11, wherein the IoT corresponds to infrastructure enabling service through an interconnection between objects on the basis of a communicator capable of information interoperation, and
the device corresponds to equipment provided with an ability to perform sensing, actuating, data capturing, data storing, or data processing with regard to the IoT.
